(19) United States
(12) Patent Application Publication
(10) Pub. No.: US 2026/0242893 A1
(43) Pub. Date: Aug. 20, 2026

(54) Shaft furnace for the smelting of copper and method therefor

(71) Applicant: SMS group GmbH, Mönchengladbach (DE)

(72) Inventors: Björn KLUMBIES, Krefeld (DE); Thomas LEISTEN, Hückelhoven (DE); Sabine LIPSKI, Erkelenz (DE)

(73) Assignee: SMS group GmbH, Mönchengladbach (DE)

(21) Appl. No.: 18/874,491

(22) PCT Filed: Jun. 6, 2023
(86) PCT No.: PCT/EP2023/065048

§ 371 Date: Dec. 12, 2024

(30) Foreign Application Priority Data
Jun. 17, 2022 (DE) 10 2022 206 100.4

(51) Int. Cl. C22B 15/02; C22B 15/00; F27B 1/14; F27B 1/28; F27D 1/00; F27D 3/00; F27D 3/15; F27D 19/00; F27D 21/00

(52) U.S. Cl. CPC C22B 15/0032; C22B 15/0095; F27B 1/14; F27B 1/28; F27D 3/0025; F27D 3/1518; F27D 19/00; F27D 21/0014; F27D 2001/0059; F27D 2019/004; F27D 2019/0075; F27M 2003/13

(57) ABSTRACT

A shaft furnace for smelting charge material to form molten copper includes a vertically disposed steel shell and a refractory lining disposed therein. The steel shell has a charge port for feeding the charge material into the shaft furnace and a taphole for withdrawing the molten copper from the shaft furnace. A plurality of burners is disposed at a plurality of levels and in rows around the circumference of the shaft furnace, for heating the charge material and for smelting the copper between the charge port and the taphole. The steel shell of the shaft furnace is cylindrical at least in an upper region above the topmost burner or the topmost row of burners. The refractory lining includes a sequence of cylindrical portions in the upper region from top to bottom. The portions are mutually concentric and the diameter of the portions increases from portion to portion.

### CROSS-REFERENCE TO RELATED APPLICATION

This application is a national stage application, filed under 35 U.S.C. § 371, of International Patent Application PCT/EP 2023/065048, filed on Jun. 6, 2023, which claims the benefit of German Patent Application DE 10 2022 206 100.4, filed on Jun. 17, 2022.

### TECHNICAL FIELD

The disclosure relates to a shaft furnace for smelting charge material, in particular copper cathodes, to form molten copper. The disclosure also relates to a method for smelting charge material such as copper cathodes to form molten copper in such a shaft furnace.

### BACKGROUND

Processes and shaft furnaces, also known as vertical furnaces, for smelting copper have been known from the prior art for decades. Copper is charged into this furnace in solid form via an upper charge port and heated and smelted by means of burners disposed in a lower region of the shaft furnace, such as gas burners, and finally discharged out of the shaft furnace via a taphole disposed in the lower region of the shaft furnace, for example via a connecting channel into a holding furnace or directly to a corresponding casting device. As the charge material passes through the shaft furnace from top to bottom, it is continuously heated and reaches the minimum temperature of approximately 1250° Celsius required for smelting copper in the smelting zone. The shaft furnace typically consists of a cylindrical steel shell and a refractory lining disposed therein.

Such a shaft furnace and a method for operating it are known, for example, from DE 2 062 144 A1. CN 214701690 U also describes a vertical furnace for the production of copper with a vertically disposed furnace body.

It is known from the prior art to, with the aid of a camera, monitor the fill level of the shaft furnace, which should preferably be filled with copper cathodes to at least 1 m below the charge port. If the fill level drops, the operator charges new cathodes into the furnace. The steel structure of the furnace along with the refractory lining between the charging and burner region is typically designed as a cylinder. The bricks of the refractory lining are designed in such a way that the long side preferably follows the radius of the combustion chamber formed by the steel shell. Here, it is necessary in particular to avoid blockages during the filling process, such as jamming when sliding down the shaft, wherein any deviation from the cylindrical shape of the steel shell of the shaft furnace or from the shaped bricks adapted to the furnace geometry is complex in terms of production, assembly and statics.

In addition, the setting of the burner output is usually designed in such a way that the output of the burners is set purely depending on the fill level of the downstream holding furnace, which acts as a reservoir for the downstream casting plant.

The molten copper runs off continuously via the typically inclined base region of the shaft furnace below the lowest row of burners and is fed into the connecting channel to the holding furnace via a brick-tiled taphole embedded in the furnace wall. Here, the dimensioning of the taphole is based on experience.

A disadvantage of the prior art known from practice is that monitoring the fill level with the aid of a camera requires the constant attention of the plant operator. He is typically responsible for ensuring that a new load of cathodes is tipped into the furnace on a timely basis via the charging device. If charging takes place too early, the cathodes cannot be positioned in the preferred vertical alignment by the charging device and are positioned at an angle or horizontally in the shaft. In the further course, this hinders the optimal heat exchange between the exhaust gas and the cathode material sliding down. If, on the other hand, charging takes place too late, the brick lining will be damaged where the cathodes strike the refractory lining from too great a fall height. Furthermore, energy efficiency is reduced if the furnace is not continuously filled to capacity.

During charging, the cathodes fall in a relatively random alignment onto the previously charged cathode layer. The burners in the lower region of the furnace melt the cathodes, and the melt that flows out of the base of the furnace flows out through the taphole. The cathodes slide continuously from top to bottom, wherein the temperature increases steadily from top to bottom. In the process, the brick lining and the cathodes expand and often become wedged together. They often only slide if additional cathodes are charged from above/if the jammed material has deformed and torn loose. This leads to the supply to the burner region no longer being carried out continuously, but in pulses, thus causing the smelting rate of the shaft furnace to vary.

The frequent interruption of the continuous sliding down known from practice and the resulting fluctuating smelting rate make automated operation of the furnace difficult or even impossible, the burner output must be changed frequently, and in some cases the distribution of the output between the individual burners must be varied.

Moreover, the geometry of the taphole is highly important for the energy balance of the furnace and its reliability. If the taphole is too large, for example, too much energy escapes via the taphole into the adjacent connecting channel and causes problems there, for example the overheating of the burners positioned there. However, if it is too small, there is a risk of clogging and freezing of copper in the base region of the shaft furnace. With the current prior art, however, subsequent optimization of the geometry of the taphole is only possible after the furnace has been shut down and the brick lining inside the furnace has been reworked.

### SUMMARY

The disclosure relates to a shaft furnace for smelting charge material, in particular copper cathodes, to form molten copper, with a vertically disposed steel shell and a refractory lining disposed therein, wherein the steel shell has at least one charge port for feeding the charge material into the shaft furnace and a taphole for draining the molten copper out of the shaft furnace. Burners, preferably a plurality of burners disposed in rows and on a plurality of levels around the circumference of the shaft furnace, are disposed at predefined levels of the shaft furnace for heating the charge material and for smelting the copper between the charge port and the taphole. The disclosure also relates to a method for smelting charge material such as copper cathodes to form molten copper in such a shaft furnace.

It was an object of the disclosure to monitor the furnace fill level ideally automatically and to replace the user control. Furthermore, it should be possible to avoid jamming of the cathodes in order to achieve a targeted and continuous smelting rate of the shaft furnace. It is intended to achieve automatic setting of the burner output instead of the previously known manual readjustment of the burner output. Finally, it should be possible to change and optimize the geometry of the taphole from the outside without interfering with the actual brick lining of the shaft furnace, as a result of which a continuous and steady operation of the shaft furnace can ultimately be achieved with preferably significantly reduced energy consumption.

This object is achieved by a shaft furnace and by a method as disclosed herein.

A shaft furnace for smelting charge material to form molten copper is provided, which has a vertically disposed steel shell and a refractory lining disposed therein. The shaft furnace has at least one charge port for feeding the charge material into the shaft furnace along with a taphole for draining the molten copper out of the shaft furnace. Burners, preferably a plurality of burners disposed in a plurality of levels and in rows around the circumference of the shaft furnace, for heating the charge material and smelting the copper are disposed at predefined levels of the shaft furnace between the charge port and the taphole. The steel shell of the shaft furnace is cylindrical at least in an upper region above the topmost burner or the topmost row of burners, and the refractory lining comprises a sequence of cylindrical portions in the upper region from top to bottom, which are disposed concentrically to one another and have a respective diameter that increases from portion to portion. The diameter of the second portion adjacent to a first portion is at least 16 mm, preferably at least 20 mm, larger than the diameter of the first portion and the cylindrical portions in each case have a height of at least 1200 mm, preferably more than 1300 mm, in particular between 1300 mm and 1400 mm.

A shaft furnace is thus provided, the internal diameter of which is gradually increased at least in a partial region, preferably in a substantial part (more than 70%, preferably more than 80% of the shaft length) of the shaft above the burners, in particular in that part of the shaft that adjoins the region below the charge port and extends up to the topmost burner level, particularly preferably over the entire length of the shaft above the burners, in order to make possible the continuous and trouble-free sliding down of solid charge material, for example in the form of copper cathode plates, despite the heating of both the refractory lining and the charge material during operation of the shaft furnace.

It is particularly preferred if the shaft furnace has at least three, preferably at least five such successive and adjacent portions with gradually increasing internal diameters of the refractory lining.

As a result, while retaining a cylindrical steel shell, this ensures that wedging of the cathodes within the shaft furnace can be reduced or completely avoided despite the heat-induced expansion of the brick lining and cathodes. The charged cathodes can slide down despite the thermal expansion and ensure continuous furnace operation. The temperature within the shaft furnace increases continuously from top to bottom, ensuring optimal heat exchange between the exhaust gas from the burners and the cathode material sliding down.

In a preferred embodiment, the diameter of the cylindrical portions of the refractory lining is designed in such a way that the thermal expansion of the refractory material, preferably the thermal expansion of the refractory material and the charge material, is at least compensated for under operating conditions of the shaft furnace. As a result, the trouble-free operation of the shaft furnace is ensured, with which the charge material, in particular the copper cathodes, can securely pass from a first portion into an adjacent, underlying second portion of the refractory lining, without making it difficult for the cathode material to slide down due to jamming. The terms “first portion” and “second portion” as used in this application refer to any pair of two portions disposed one above the other and adjacent to one another.

In a further preferred embodiment, at least one sensor, preferably three sensors disposed one above the other, is provided for measuring the fill level of the shaft furnace with charge material. These sensors are particularly preferably disposed above the topmost burner level and directly below the charge port, particularly preferably no more than 1 m in relation to the topmost sensor below the charge port. In a highly preferred embodiment, the at least one sensor, preferably the three sensors, is in each case assigned a receiver, which is particularly preferably disposed opposite the respective sensor at the level of the respective sensor of the shaft furnace. As a result, a simple and reliable measurement of the fill level of the shaft furnace is ensured, which makes visual inspection unnecessary.

As a result, the sensors measure the fill level of the shaft horizontally and can determine whether the shaft furnace is filled at the respective level that is covered by the sensor, if applicable the receiver connected to it. It is preferable if an alarm signal is emitted if the fill level does not reach a predefined threshold value, which indicates whether a new charging is necessary. In this connection, it is particularly preferable if the sensors are connected to a device that automatically triggers a refill by the charging system when a predefined threshold value is not reached. As a result, a higher degree of automation than in the previously known shaft furnaces for smelting charge material to form molten copper is achieved using particularly simple means.

The ideally three sensors are mounted below the charging level in the shaft furnace at distances of preferably 400-600 mm, in particular 450-550 mm, very particularly preferably 500 mm, from one another and measure whether there is charge material at the scanned level. In this region of the shaft furnace, in which the copper heats up from room temperature to almost the smelting temperature, the jamming of the copper cathodes or any other charge material is prevented by at least compensating for the thermal expansion of the charge material by gradually increasing the diameter of the refractory material from top to bottom. The thermal expansion of the copper amounts to 16.5*10\hat{ }−6 1/K and that of the brick lining approximately 5*10\hat{ }−6 1/K. The brick lining is designed in such a way that, on the one hand, the cost-effective cylindrical outer shape of the steel shell and the refractory material above the burner rows is retained and, on the other hand, the load-bearing capacity of the refractory lining is ensured and the fabrication of the prefabricated bricks remains as cost-effective as possible.

It is preferable if a measuring sensor, preferably a measuring lance connected to the shaft furnace, is disposed in the region of the taphole for measuring the temperature of the molten copper as it exits the taphole. In particular, if the current production rate of the downstream casting plant is also measured, the heat balance of the shaft furnace can be calculated with the aid of a process model and the required current gas quantity/burner output of the individual burners or burner rows can be determined. This results in the basic setting of the burners; the burner output is typically set in such a way that the burners in each row operate in each case at the same output and the output distribution of the individual rows is set in advance. In particular, if the current weight along with the change in weight of the molten copper in the holding furnace downstream of the shaft furnace are determined, these values can be used to continuously correct the above-mentioned setting. With the aid of this regulation, no further manual intervention is necessary for the burner setting, in particular after the shaft furnace has been started up; the operation of the shaft furnace is then preferably carried out completely automatically.

It is also preferable if the refractory lining for the taphole is designed to project from the region of the refractory lining and through the steel shell from the inside to the outside beyond the longitudinal extent of the steel shell. Preferably, in the process the height of the taphole is defined by a shaped brick, which is inserted laterally into the adjacent refractory bricks and fixed from above by further bricks. In this connection, it is particularly preferred that the part of the refractory lining projecting beyond the steel shell of the shaft furnace, in particular the shaped brick and the refractory bricks surrounding it, is surrounded by a steel collar or a steel frame, via which the tightness of this region of the shaft furnace around the opening of the shaped brick can be ensured. In this connection, it is particularly preferred if a part of the steel collar or the steel frame, in particular an upper steel plate, is detachably connected to it. The detachable connection of the steel plate to the rest of the steel collar or the steel frame can preferably be achieved by means of clamping or bolting. After removing the steel plate, unhindered access to the refractory bricks and/or the shaped brick embedded in the steel collar or the steel frame can be made possible without having to reach into the interior of the shaft furnace.

It is also particularly preferred if a holding furnace is disposed downstream of the taphole of the shaft furnace, which holding furnace is connected to a sensor, preferably a weighing cell, for measuring the weight of the melt in the holding furnace and for detecting the change in weight in the holding furnace. As a result, a measurement parameter is obtained using particularly simple means that allows the heat balance of the shaft furnace and the associated required current gas quantity/burner output to be calculated with the aid of a process model.

It is particularly preferred if the output of each row of burners, preferably of each individual burner, can be regulated or controlled individually and preferably automatically.

In a further preferred embodiment, a plurality of thermocouples are provided in the region of the refractory lining, in particular in the region of the burners and/or in the shaft disposed above them for detecting the temperature of the refractory lining. The measured values that can be detected as a result can be used for optimizing the temperatures of the brick lining with regard to its service life and can be called on for operating the shaft furnace, preferably automatically.

Furthermore, it is preferred if a control or regulating unit is configured and designed to control or regulate the fill level of the shaft furnace and/or the smelting rate of the shaft furnace, preferably automatically, in particular to ensure a continuous feed of charge material and/or a smelting rate that is as constant as possible. All of this serves to increase the efficiency of the shaft furnace and to achieve the highest possible thermal efficiency.

In accordance with a further aspect, a method for smelting charge material to form molten copper in a shaft furnace is provided, in accordance with the first aspect described above. The method is characterized in that a control or regulating unit controls or regulates the charging of the shaft furnace, the fill level within the shaft furnace and the output of each row of burners, preferably of each individual burner, preferably automatically. The height of the taphole and/or its geometry, in particular the size of the taphole, and associated therewith the quantity of hot air or hot gas exiting the shaft furnace per unit of time, can be varied.

In this connection, it is particularly preferred that the control or regulating unit calculates the heat balance of the shaft furnace on the basis of measured parameters and using a process model.

The measured parameters used for this purpose comprise the fill level of the shaft furnace, the temperature of the molten copper as it exits the taphole and preferably also the weight and/or the change in weight of the molten copper within a holding furnace disposed downstream of the taphole, particularly preferably also the production rate of a casting plant downstream of the shaft furnace.

In this connection, it is particularly preferable if the measured parameters for calculating the heat balance of the shaft furnace are entered into a process model, by means of which the currently required burner output, particularly the fuel quantity required by each burner, is determined.

The geometry of the taphole is also decisive for the energy balance of the furnace, and the same applies to the reliability of shaft furnace operation as a whole. The taphole geometry significantly limits the quantity of hot air exiting the shaft furnace into the connecting channel. The lower the quantity of hot air, the more energy-efficient the shaft furnace can be operated overall. At the same time, it must be taken into account that slag in particular can hinder the exit of molten copper from the taphole. It is therefore particularly advantageous if the components defining the taphole, such as the shaped brick and the refractory bricks surrounding the shaped brick, are easily accessible and disposed outside the steel shell. In addition, the provision of a steel collar or frame around the parts of the taphole projecting from the steel shell makes possible the efficient limitation of the undesired exit of hot air. With the preferred detachable steel plate on the steel collar or the steel frame, access to all components of the taphole is nevertheless easy to implement.

It can thus be ensured that the smelting rate of the shaft furnace does not vary or varies only minimally. In addition, it can be ensured that the shaft furnace is optimal filled, as a result of which a high level of thermal efficiency can be achieved. Due to the continuous feed of charge material to the burner chamber, an effective regulation of the smelting rate of the shaft furnace can be achieved, and at the same time, the automatic setting of the burners can be carried out through the implemented regulation system. Finally, due to the optimization of the taphole height, the energy balance of the furnace can be further improved.

### BRIEF DESCRIPTION OF THE DRAWINGS

The invention is explained in more detail below with reference to five figures, wherein these figures illustrates preferred embodiments that do not limit the scope of protection of the invention.

FIG. 1 shows a schematic sectional view of a shaft furnace,

FIG. 2 shows a detailed view of an upper region of the shaft furnace in accordance with FIG. 1,

FIG. 3 shows a sectional view through the refractory lining in the region of the taphole of a shaft furnace,

FIG. 4 shows is a schematic sectional view of a system for measuring the fill level in three levels, and

FIG. 5 shows a schematic diagram of the automatic burner regulation in the shaft furnace.

### DETAILED DESCRIPTION

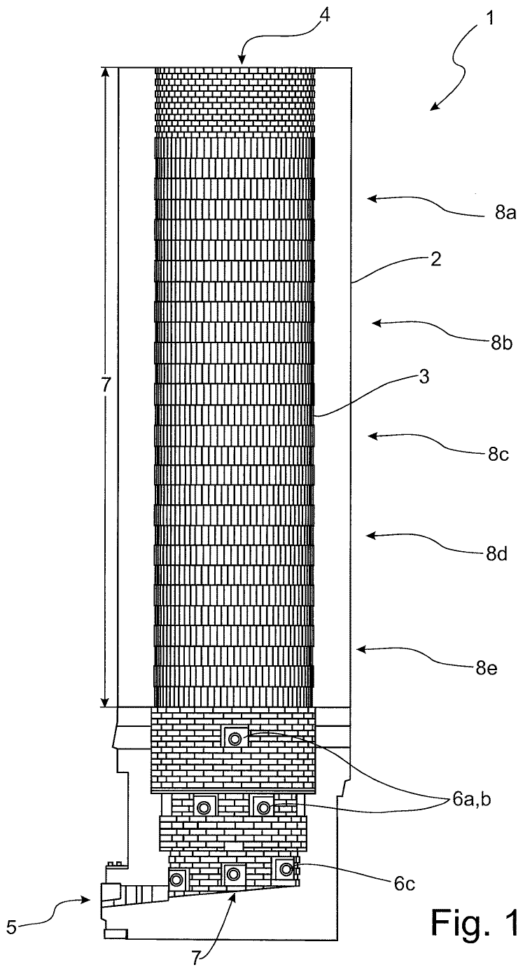

FIG. 1 shows a cross-sectional view of a shaft furnace 1 in accordance with the invention for smelting charge material to form molten copper. The shaft furnace 1 consists of a vertically disposed steel shell 2 and a refractory lining 3. The steel shell 2 has a charge port 4 disposed at the top of the shaft furnace 1 for feeding the charge material into the shaft furnace 1 and a taphole 5 for draining the molten copper out of the shaft furnace 1. In the lower region of the shaft furnace 1, burners 6 are disposed in rows or levels around the circumference of the shaft furnace 1, wherein three rows of burners 6 are provided in the present embodiment. While the upper two rows of burners 6a,b are disposed at a horizontal level in the shaft furnace 1, the level for the lower row of burners 6c is substantially parallel to a sloping base level 7 in the shaft furnace 1, along which the molten copper in the region of the burners 6 is guided towards the taphole 5. Above the region of the burners 6, the shaft furnace 1 has a shaft region 7, in which substantially solid charge material in the form of copper cathodes is conveyed from top to bottom on the basis of gravity and is continuously heated there from the charging temperature to the smelting temperature. In the present case, the shaft region 7 of the shaft furnace 1 above the burners 6 has a height of approximately 9 m with a minimum internal diameter of 1804 mm. The shaft region 7 of the shaft furnace 1 above the burners 6 consists of a plurality of cylindrical portions 8a-e, the diameter of which increases in each case by 20 mm from portion 8 to portion 8. The diameters of the portions 8 are designed in such a way that, even when the refractory material is heated, which has a temperature gradient both from top to bottom and from inside to outside, the secure sliding of the charge material from top to bottom is also ensured over the plurality of portions 8a-e of the refractory lining 3.

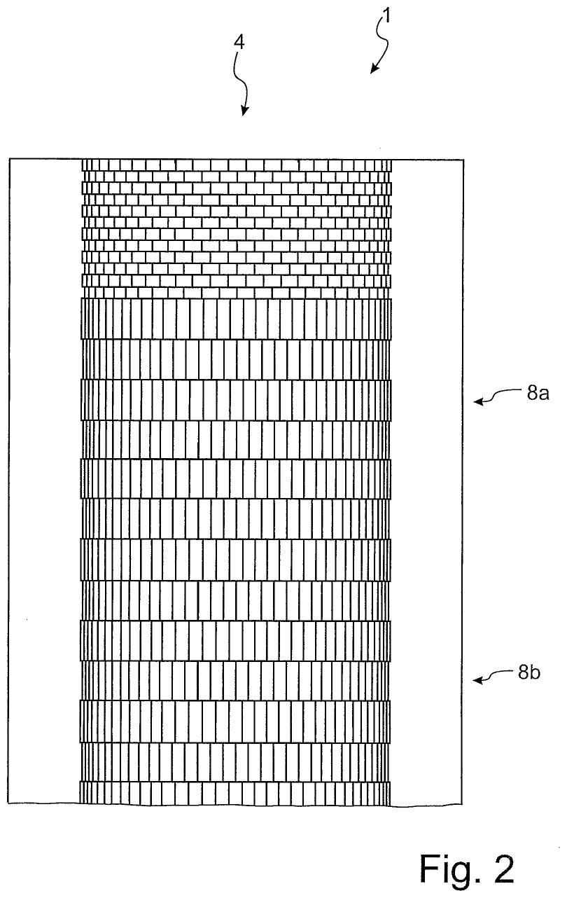

FIG. 2 shows a detailed view of the upper region of the shaft furnace 1 from FIG. 1. In the region of the charge port 4, a cylindrical section of the refractory lining 3 with a diameter of 1804 mm is provided, which is adjoined downwards in the direction of gravity by a first portion 8a of the refractory lining 3. Following this, a further portion 8b is provided in the refractory lining 3, which again has an inner diameter that is 20 mm larger than in the upper, adjacent portion 8a, thus amounting to 1844 mm.

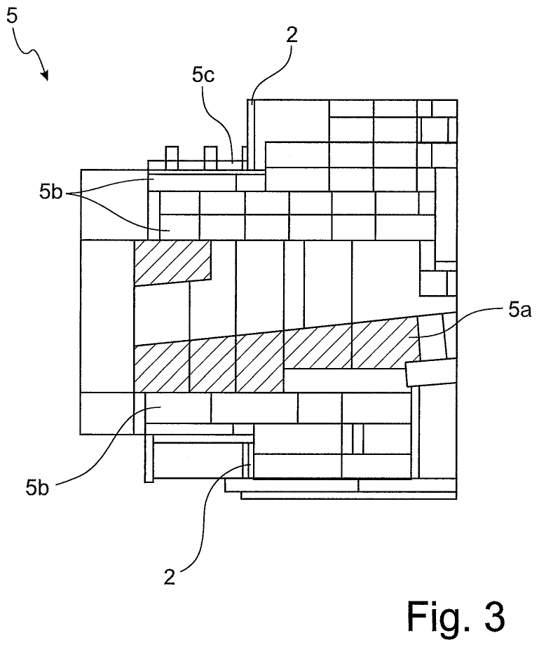

FIG. 3 shows a cross-sectional view through the region of the shaft furnace (not shown) in the region of the taphole 5. The taphole 5 is defined by a shaped brick 5a, which is surrounded at the top and bottom by a row of refractory bricks 5b. Both the shaped brick 5a and the refractory bricks 5b directly adjacent to the shaped brick 5a are disposed in such a way that at least part of the shaped brick 5a projects out of the shaft furnace 1 beyond the longitudinal extent of the steel shell 2. This projecting section of the shaped brick 5a and the refractory bricks 5b surrounding it is surrounded by a steel collar or a steel frame adjacent to the steel shell 2. An integral component of this steel collar or the steel frame is an upper steel plate 5c, which is detachably connected to the steel collar or the steel frame via clamping elements. If the steel plate 5c is removed, there is substantially unimpeded access to those parts of the refractory components of the taphole 5 that project beyond the steel shell 2.

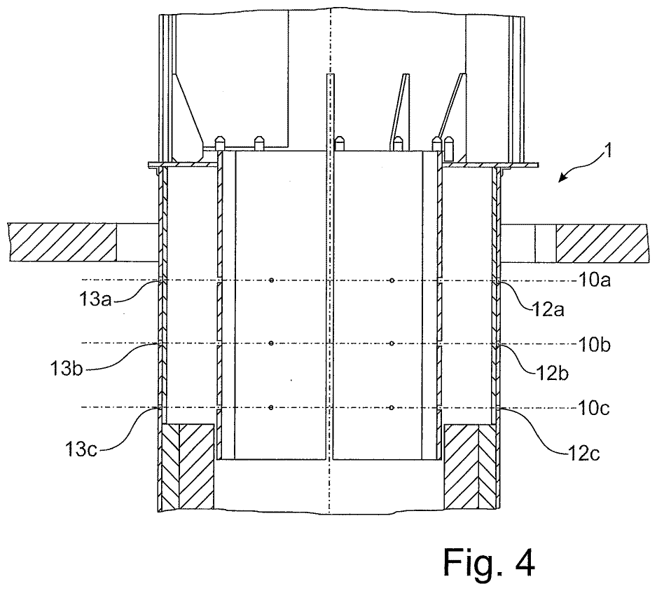

FIG. 4 shows a schematic partial view of the upper region of the shaft furnace 1 approximately 1 m below the charge port (not shown). Three sensors 12a to 12c and three receivers 13a to 13c are shown on the outside of the steel shell 2 in three levels 10a to 10c approximately 1 m below the charge port (not shown) and at a distance of approximately 500 mm from one another. Thus, by means of the sensors 12a to 12c, it can be determined whether or not there is solid charge material within the shaft furnace 1 at the level of the sensors 12a to 12c and receivers 13a to 13c.

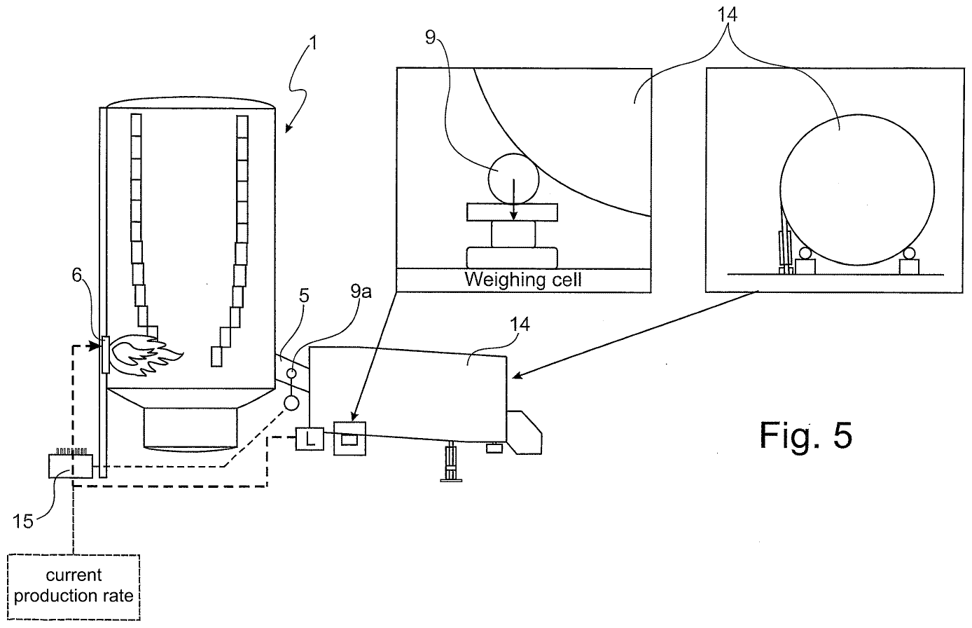

FIG. 5 shows a schematic diagram of the automatic regulation of the burner output within a shaft furnace 1 in accordance with the invention. The measurement of the temperature of the molten copper exiting the taphole 5 by means of a measuring cell 9a along with the weight of the copper smelted in a holding furnace 14 by means of a measuring cell 9 are fed to a control or regulating unit 15, via which the output of a respective burner 6 within the shaft furnace 1 is set, taking into account the current production rate of the downstream casting plant, which is not shown. As a result, the constant operation of the shaft furnace 1 substantially automatically with preferably constant burner output and a constant flow of molten copper from the taphole 5 into the holding furnace 14 are ensured.

### LIST OF REFERENCE SIGNS

1 Shaft furnace
2 Steel shell
3 Refractory lining
4 Charge opening
5 Taphole
5a Shaped brick
5b Refractory brick
5c Steel plate
6 Burner
7 Base level
8 Shaft region
9 Measuring cell
9a Measuring cell
10a-10c Sensor level
12a-12c Sensors
13a-13c Receivers
14 Holding furnace
15 Control or regulating unit

1.-23. (canceled)

24. A shaft furnace (1) for smelting a charge material to form molten copper, comprising:
a vertically disposed steel shell (2), including
a refractory lining (3) disposed in the vertically disposed steel shell (2),
a charge port (4) for feeding the charge material into the shaft furnace (1), and
a taphole (5) for draining the molten copper out of the shaft furnace (1); and
a plurality of burners (6) for heating the charge material and for smelting the copper disposed at predefined levels of the shaft furnace (1) between the charge port (4) and the taphole (5),
wherein the steel shell (2) of the shaft furnace (1) is cylindrical at least in an upper region (7) above a topmost one of the burners (6) or a topmost row of the burners (6), and
wherein the refractory lining (3) comprises a sequence of cylindrical portions (8a-e) in the upper region (7),
wherein the cylindrical portions are mutually concentric, and
wherein the cylindrical portions include a first portion (8a) and a second portion (8b), the second portion (8b) being arranged adjacent to and below the first portion (8a),
wherein a diameter of the second portion (8b) is at least 16 mm larger than a diameter of the first portion (8a), and
wherein the cylindrical portions (8a-e) each a height of at least 1200 mm.

25. The shaft furnace (1) according to claim 24,
wherein the plurality of burners (6) are disposed at a plurality of levels and in rows around a circumference of the shaft furnace (1).

26. The shaft furnace (1) according to claim 24,
wherein the diameter of the cylindrical portions (8a-e) of the refractory lining (3) is designed in such a way that a thermal expansion of the refractory material (3) is compensated for under operating conditions of the shaft furnace (1).

27. The shaft furnace (1) according to claim 24,
wherein the diameter of the second portion (8b) is at least 20 mm larger than the diameter of the first portion (8a).

28. The shaft furnace (1) according to claim 24,
wherein the cylindrical portions (8a-e) each have a height between 1300 mm and 1400 mm.

29. The shaft furnace (1) according to claim 24,
wherein the cylindrical portions include at least four cylindrical portions (8a-e) disposed one above another.

30. The shaft furnace (1) according to claim 24, further comprising three sensors (12a-c) disposed one above another for measuring a fill level of the shaft furnace (1) with charge material,
wherein the three sensors (12a-c) are arranged above the topmost burner level (6a), and
wherein a topmost one of the three sensors (12a-c) is arranged no more than 1 m below the charge port (4).

31. The shaft furnace (1) according to claim 30,
wherein a respective receiver (13) is assigned to each of the three sensors (12a-c) and disposed opposite the respective sensor (12) at a respective level (10) of the shaft furnace (1).

32. The shaft furnace (1) according to claim 24, further comprising
a measuring lance, the measuring lance being disposed in a region of the taphole (5) for measuring a temperature of the molten copper as it exits the taphole (5).

33. The shaft furnace (1) according to claim 24,
wherein the refractory lining (3) is provided in a region of the taphole (5) so as to project laterally from an inside to an outside beyond the steel shell (2).

34. The shaft furnace (1) according to claim 24,
wherein the refractory lining (3) has, in a region of the taphole (5), a shaped brick (5a) defining a height of the taphole (5),
wherein the shaped brick (5a) is surrounded both from above and below and laterally by refractory bricks (5b) of the refractory lining (3) adjoining the shaped brick (5a),
wherein the shaped brick (5a) and the refractory bricks (5b) surrounding the shaped brick (5a) that are disposed so as to project beyond the steel shell (2) are surrounded by a steel collar or a steel frame,
wherein the steel collar or the steel frame has a steel plate (5c) arranged at a top of the steel collar or the steel frame, and
wherein the steel plate is detachably connected to the steel collar or the steel frame.

35. The shaft furnace (1) according to claim 34,
wherein the steel plate (5c) is connected to the steel collar or the steel frame by clamping or bolting.

36. The shaft furnace (1) according to claim 24,
wherein a holding furnace (14) is disposed downstream of the taphole (5) of the shaft furnace (1), and
wherein the holding furnace (14) is connected to a weighing cell (9) for measuring a weight of a melt in the holding furnace (14) and for detecting a change in the weight of the melt in the holding furnace (14).

37. The shaft furnace (1) according to claim 30, wherein the three sensors (12) are connected to a monitoring unit, and
wherein the monitoring unit is configured to output a warning signal when the filling of the shaft furnace (1) with charge material does not reach a predefined threshold value, and to output a command for automatic charging of the shaft furnace (1) with charge material.

38. The shaft furnace (1) according to claim 24,
wherein the shaft furnace (1) is connected to a control or regulating unit (15),
wherein the control or regulating unit (15) calculates a heat balance of the shaft furnace (1) based measured parameters and using a process model and determines a current required burner output in form of a current required fuel quantity therefrom.

39. The shaft furnace (1) according to claim 38,
wherein the control or regulating unit (15) is configured to control or regulate an output of each of the burners (6) individually and automatically.

40. The shaft furnace (1) according to claim 24, further comprising
a plurality of thermocouples arranged in a region of the burners (6) and/or in the upper region (7) disposed above the burners (6) for detecting a temperature of the refractory lining (3).

41. The shaft furnace (1) according to claim 38,
wherein the control or regulating unit (15) is configured to control or regulate a fill level of the shaft furnace (1) and/or a smelting rate of the shaft furnace (1), to ensure a continuous feed of charge material and/or a smelting rate that is as constant as possible.

42. A method, comprising:
providing the shaft furnace (1) according to claim 24;
controlling or regulating, by a control or regulating unit (15),
a charging of the shaft furnace (1),
a fill level within the shaft furnace (1), and
an output of each of the burners (6); and
varying a height of the taphole (5), a geometry of the taphole (5), and/or a size of the taphole (5), and thereby a quantity of hot air or hot gas exiting the shaft furnace (1) per unit of time.

43. The method according to claim 42,
wherein the control or regulating unit (15) calculates the heat balance of the shaft furnace (1) based on measured parameters and using a process model.

44. The method according to claim 43,
wherein the measured parameters comprise a fill level of the shaft furnace (1), a temperature of the molten copper as it exits the taphole (5) and a weight and/or a change in weight of the molten copper within a holding furnace (14) disposed downstream of the taphole (5).

45. The method according to claim 43,
wherein the measured parameters for calculating the heat balance of the shaft furnace (1) are entered into a process model, by which a fuel quantity required by each of the burners (6) is determined.

46. The method according to claim 41, wherein operation of the shaft furnace (1) is carried out automatically at least after a start-up.
